(19) United States
(12) Patent Application Publication
(10) Pub. No.: US 2026/0189615 A1
(43) Pub. Date: Jul. 2, 2026

(54) DYNAMIC AUDIO SHARING DURING VOICE AND VIDEO CALLS

(71) Applicant: Motorola Mobility LLC, Chicago, IL (US)

(72) Inventors: Amit Kumar Agrawal, Bangalore (IN); Himanshu Chug, Bangalore (IN); Plinio van Deursen, São Paulo (BR)

(73) Assignee: Motorola Mobility LLC, Chicago, IL (US)

(21) Appl. No.: 19/006,470

(22) Filed: Dec. 31, 2024

(51) Int. Cl. H04L 65/1089; H04L 65/1096; H04L 65/613; H04M 3/42

(52) U.S. Cl. CPC H04L 65/1089; H04L 65/1096; H04M 3/42221; H04L 65/613; H04M 2201/40; H04M 2201/42

(57) ABSTRACT

In accordance with the described techniques, a call is initiated between a source device and one or more remote devices. During the call, an intent is detected to share audio data of a media content item displayed in a user interface of the source device to the one or more remote devices. In response to the intent being detected, a playback sharing setting is enabled. Based on the playback sharing setting being enabled, the audio data of the media content item that is being played back at the source device is communicated for playback at the one or more remote devices.

### BACKGROUND

Voice and video calls have become ubiquitous forms of communication, enabling real-time audio and visual interactions between participants across distances. These calls often involve sharing various types of content, such as presentations, documents, or multimedia files. Audio sharing during calls allows participants to hear audio that is played back at a remote presenter's device, enhancing the collaborative experience. This capability is useful for scenarios like playing video clips, demonstrating software with audio feedback, or sharing music samples. The ability to selectively share audio content during calls has applications in fields such as remote education, virtual meetings, online presentations, and collaborative media production.

### BRIEF DESCRIPTION OF THE DRAWINGS

Aspects of dynamic audio sharing during voice and video calls are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of dynamic audio sharing during voice and video calls can be implemented.

FIG. 2 illustrates an example system for dynamic audio sharing during voice and video calls.

FIG. 3 depicts an example user interface for specifying playback sharing setting preferences of a user.

FIG. 4 depicts an example of enabling a playback sharing setting based on a playback initiation.

FIG. 5 illustrates an example of enabling a playback sharing setting based on a media icon detection within a user interface of a source device operating in a presentation mode.

FIG. 6 illustrates an example of enabling a playback sharing setting based on a transcript of a call between a source device and one or more remote devices.

FIG. 7 illustrates a flow chart depicting an example method of dynamic audio sharing during voice and video calls.

FIG. 8 illustrates various components of an example device in which aspects of dynamic audio sharing during voice and video calls can be implemented.

### DETAILED DESCRIPTION

The techniques described herein relate to playback sharing. In accordance with the described techniques, a call (e.g., a voice and/or video call) is initiated between a source device and one or more remote devices. As discussed herein, “playback sharing” is the process of the source device initiating playback of a media content item (e.g., an audio file, a video, and so on) at the source device, and also routing audio data of the media content to the one or more remote devices. In this way, the source device and the one or more remote devices output the audio data of the media content item concurrently, so that all participants on the call can consume audio and/or multimedia content together.

Conventional playback sharing techniques involve manually enabling and disabling a playback sharing setting. Typically, the playback sharing setting is disabled by default in order to prevent unwanted audio (e.g., notification audio from notification messages, like emails, chat messages, reminders, and so on) from being communicated to other participants on the call, and disrupting the call. Oftentimes, users are unaware of this setting and/or lack knowledge of how to enable and disable this setting. Thus, when these users intend to playback a media content item for all parties on the call to consume, the audio is filtered out and not heard by remote device users, leading to user frustration. Even if a user is aware of this setting, the user is required to manually enable the playback sharing setting immediately before playing the media content item and manually disable the playback sharing setting immediately after the media content item is terminated, or risk unwanted audio being shared and disrupting the call. This is time consuming, tedious, and disruptive, particularly if the user is giving a presentation.

To alleviate these inconveniences, techniques for dynamic audio sharing during voice and video calls are discussed herein as implemented by a playback sharing system. In accordance with the described techniques, a call (e.g., a voice and/or video call) is initiated between the source device and one or more remote devices. During the call, a media content item is displayed in a user interface of the source device. Generally, a media content item is any digital content capable of outputting audio. Also during the call, the playback sharing system detects an intent of the source device user to share audio data of the media content item to be played back at the one or more remote devices.

The intent is detectable by the playback sharing system in a variety of ways. In one or more examples, the playback sharing system detects the intent based on the user initiating (e.g., via user input) playback of the media content item during the call. In some implementations, the playback sharing system detects the playback initiation by detecting (e.g., using a trained object detection model) one or more media icons (e.g., play/pause buttons, scrub/progress bars, fast forward and rewind buttons, and the like) that are indicative of the media content item being played back at the source device. Additionally or alternatively, the playback sharing system detects the intent based on the user initiating (e.g., via user input) playback of the media content item during the call while the source device is operating in a presentation mode. In the presentation mode (i.e., a screen sharing mode), for instance, the source device captures and transmits visual data of a live feed of the user interface of the source device (or a portion thereof) to be displayed at the one or more remote devices.

In yet other examples, the playback sharing system detects the intent to share the audio based on voice data and/or a transcript of voice communications exchanged during the call. Indeed, the playback sharing system includes functionality for generating a live transcript of the conversation between the participants of the call. Furthermore, the playback sharing system extracts (e.g., using natural language processing techniques) the intent from the transcript. By way of example, the playback sharing system extracts the intent from a portion of the transcript in which the user of the source device states, “before we end this call, I just wanted to share a quick video demonstration of the process we just discussed.”

In response to detecting the intent to share the audio data for playback at the one or more remote devices, the playback sharing system enables the playback sharing setting. Notably, enabling the playback sharing setting allows for audio that is output at the source device to also be routed for concurrent output by the one or more remote devices. In other words, enabling the playback sharing setting causes the source device to communicate the audio data of the media content item that is being played back at the source device for concurrent playback at the one or more remote devices. This enables all participants on the call to consume the audio data concurrently.

In addition, the playback sharing system is configured to automatically disable the playback sharing setting in response to playback of the media content item being terminated, e.g., the media content item being manually paused or the media content item having finished playing until an endpoint. Disabling the playback sharing setting prevents audio that is output at the source device from being communicated for output at the one or more remote devices.

Thus, the techniques discussed herein detect an intent to share audio data of the media content item displayed in the user interface of the source device with the one or more remote devices, and automatically enable a playback sharing setting to communicate the audio data for playback at the one or more remote devices. Further, the described techniques automatically disable the playback sharing setting in response to the playback termination of the media content item that was intended to be shared, thereby preventing communication of unwanted audio. By doing so, the described techniques reduce call disruptions and improve user satisfaction with voice and video calls.

While features and concepts of dynamic audio sharing during voice and video calls can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

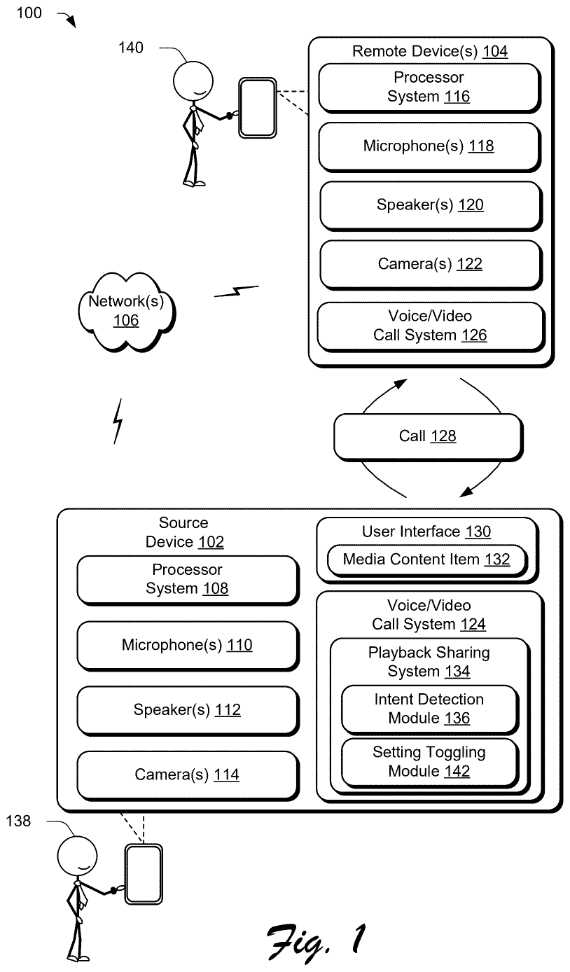

FIG. 1 illustrates an example environment 100 in which aspects of dynamic audio sharing during voice and video calls can be implemented. The environment 100 includes a source device 102 and one or more remote devices 104 that are communicatively coupled over a network 106, such as a Wi-Fi network or a cellular network. Computing devices that implement the source device 102 and the remote device(s) 104 are configurable in a variety of ways. A computing device, for instance, is configurable as a desktop computer, a laptop computer, a mobile device (e.g., assuming a handheld configuration such as a tablet or mobile phone), one or more server devices, and so forth. Additionally or alternatively, a computing device is a wearable device designed to be worn on, attached, or close to a body of a user, such as a smartwatch, a fitness tracker, smart glasses, smart jewelry, and so on. Thus, a computing device ranges from full resource devices with substantial memory and processor resources (e.g., personal computers, game consoles, server devices) to a low-resource device with limited memory and/or processing resources, e.g., mobile devices and wearable devices. Thus, although depicted as mobile devices (e.g., smartphones) in the illustrated example, the source device 102 and the remote device(s) 104 are implemented as any suitable electronic, communication, and/or mobile device.

In one or more examples, the source device 102 is implemented with various hardware resources, such as a processor system 108, one or more microphones 110, one or more speakers 112, and one or more cameras 114. In addition, the remote device(s) 104 are implemented with similar hardware resources, such as a processor system 116, one or more microphones 118, one or more speakers 120, and one or more cameras 122. Broadly, the processor system 108, 116 is representative of one or more processors configured to process computer-executable instructions, examples of which include central processing units (CPUs), graphics processing units (GPUs), application-specific integrated circuits (ASICs), field-programmable gate arrays (FPGAs), and the like. The microphones 110, 118 are transducers that convert sound waves into an electrical signal, and the microphones 110, 118 capture audio for the purpose of audio transmission (e.g., to other devices), recording, voice command recognition, and the like. The speakers 112, 120 are electronic devices that convert electrical audio signals into sound waves, thereby enabling humans to hear and consume audio.

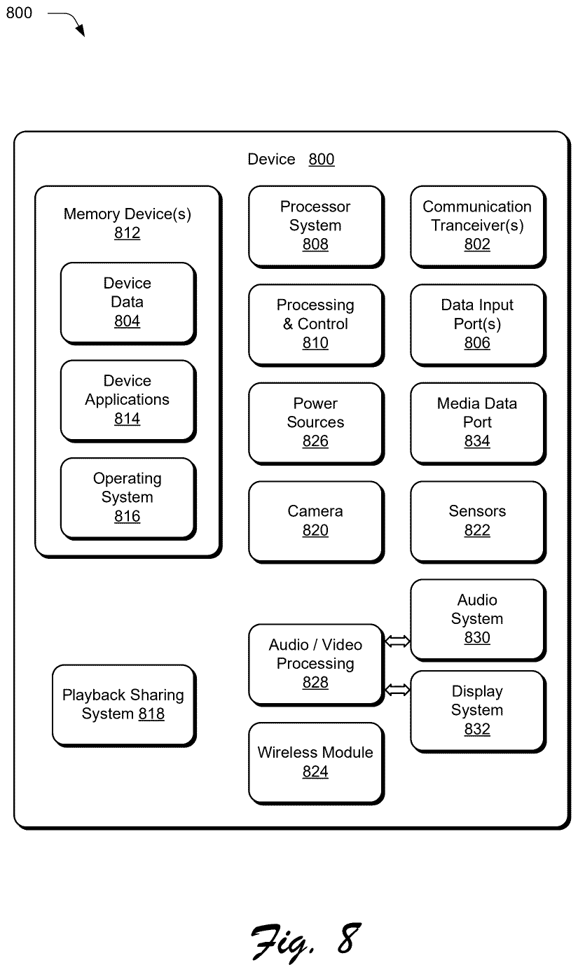

In various examples, the microphones 110, 118 and the speakers 112, 120 are integrated components of the devices 102, 104, or the microphones 110, 118 and the speakers 112, 120 are external devices communicatively coupled (e.g., via wired or wireless connections) to the devices 102, 104. By way of example, the microphones 110, 118 and the speakers 112, 120 are integrated in earbuds or headphones communicatively coupled to the source device 102 and remote device(s) 104, respectively, via wired or wireless (e.g., Bluetooth) connections. Furthermore, the camera(s) 114, 122 are representative of functionality for capturing images and videos by the source device 102 and remote device(s) 104, respectively, for purposes of photography, videography, live video feed transmission, and the like. The source device 102 and the remote device(s) 104 are also implemented with any number and any combination of different components, as further discussed below with reference to the example device 800 of FIG. 8.

Furthermore, the source device 102 is illustrated as including a voice/video call system 124, while the remote device(s) 104 similarly include a voice/video call system 126. Generally, the voice/video call system 124, 126 is representative of functionality for initiating and facilitating calls 128 (e.g., voice or video calls) with other devices. For example, the call 128 is representative of a live exchange of voice data, audio data, visual data, and/or video data between the source device 102 and the remote device(s) 104. During the call 128, for instance, the microphone(s) 110 capture audio data (e.g., voice and/or other audio), and the source device 102 transmits the audio data over the network(s) 106 to the remote device(s) 104, e.g., to be output by the speaker(s) 120. Additionally or alternatively, the camera(s) 114 capture video data during the call, and the source device 102 transmits the video data over the network(s) 106 to the remote device(s) 104, e.g., to be displayed in a user interface of the remote device(s) 104. Moreover, the source device 102 can operate in a “presentation mode” to capture and transmit visual data of a live feed of a user interface 130 (or portion thereof) displayed by the source device 102 to the remote device(s) 104, e.g., to be displayed by the remote device(s) 104.

Similar operations are performable by the remote device(s) 104 to capture audio, voice, visual, and/or video data, transmit the data to the source device 102 and/or other remote device(s) 104 for playback by the source device 102 and/or other remote devices 104. The voice data, audio data, visual data, and/or video data is exchanged during the call 128 over cellular network(s) 106 and/or Wi-Fi Networks 106 using any one or more of a variety of communication protocols and standards, examples of which include but are not limited to, Voice over Internet Protocol (VoIP), Global System for Mobile Communications (GSM), Voice over LTE (VoLTE), Voice over Wi-Fi (VoWiFi), Real-Time Transport Protocol (RTP), Secure Real-Time Transport Protocol (SRTP), and User Datagram Protocol (UDP).

During the call 128, the source device 102 displays a media content item 132 in the user interface 130. Broadly, the media content item 132 is any digital content that outputs audio. Examples of the media content item 132 include audio files, streaming media (e.g., live or on-demand audio and/or video), multimedia (such as videos, images, slideshows, and the like) with accompanying audio tracks, interactive audio sources (e.g., images or animations which, when interacted with via user input, cause sound output), broadcast content (e.g., television, radio, internet broadcasts), and so on.

The voice/video call system 124 includes a playback sharing setting that can be enabled to allow non-call audio (audio that is not received as part of the call 128) output by the speaker(s) 112 of the source device 102 to additionally be communicated, as part of the call 128, for playback at the remote device(s) 104. In addition, the playback sharing setting can be disabled to prevent (e.g., filter out) non-call audio that is output by the speaker(s) 112 of the source device 102 from being communicated, as part of the call 128, for playback at the remote device(s) 104. The playback sharing system 134 is representative of functionality for automatically enabling the playback sharing setting in response to detecting an intent to share audio data of the media content item 132, and automatically disabling the playback sharing setting in response to detecting that playback of the media content item 132 at the source device 102 has been terminated.

As part of this, the playback sharing system includes an intent detection module 136, which is configured to detect an intent of a user 138 of the source device 102 to share the audio data of the media content item 132 with user(s) 140 of the remote device(s) 104 that are participants to the call 128. The intent is detectable in various ways, as further discussed below. For instance, the intent is detectable as the user 138 initiating the playback of the media content item 132 (e.g., via user input) during the call 128 and/or while the source device 102 is operating in the presentation mode. In various implementations, the intent detection module 136 includes functionality (e.g., an object detection model) for detecting media icons (e.g., play/pause buttons, progress/scrub bars, fast forward and rewind buttons, and the like) in the user interface 130 indicative of the media content item 132 being played back at the source device 102, and the playback initiation of the media content item 132 is detected based on a detection of these media icons. Additionally or alternatively, the intent is detectable based on voice data captured by the microphone(s) 110 of the source device 102 (e.g., words spoken by the user 138) and/or an automatically-generated transcript of the call 128 expressing an intent by the user 138 to share the audio data of the media content item 132.

In response to the intent being detected, a setting toggling module 142 is configured to enable the playback sharing setting. By doing so, the voice/video call system 124 is able to communicate the audio data of the media content item 132 for playback at the one or more remote devices 104. Furthermore, the playback sharing system 134 includes functionality for detecting that playback of the media content item 132 has terminated. In response to the playback termination being detected, the setting toggling module 142 is configured to disable the playback sharing setting. By doing so, the voice/video call system 124 prevents audio that is played back at the source device 102, but is not intended to be shared, from being communicated for playback at the one or more remote devices 104.

Although examples are described herein in which the functionality of the playback sharing system 134 is implemented by the source device 102, these examples are not to be construed as limiting. Rather, in variations, the remote devices 104 include instances of the playback sharing system 134 within the voice/video call system 126. Accordingly, similar operations are performable by the remote device 104 to detect an intent of the user 140 to share audio data of a media content item 132 displayed by the remote device 104, automatically enable the playback sharing setting to allow communication of the audio data to the source device 102 and/or other remote device(s) 104, and automatically disable the playback sharing setting in response to playback of the media content item 132 having terminated.

Conventional playback sharing techniques involve manually enabling and disabling the playback sharing setting. Typically, the playback sharing setting is disabled by default to prevent unwanted audio (e.g., notification audio from notification messages, like emails, received voice calls, chat messages, and reminders) from being communicated to other participants on the call, and disrupting the conversation. Oftentimes, users are unaware of this setting and/or lack knowledge of how to enable and disable this setting. Thus, when these users intend to playback a media content item for all parties on the call to consume, the audio is filtered out and not heard by remote device users, leading to user frustration. Even if a user is aware of this setting, the user is required to manually enable the playback sharing setting immediately before playing the media content item and manually disable the playback sharing setting immediately after the media content item is terminated, or risk unwanted audio being shared and disrupting the call. This is time consuming, tedious, and disruptive if the user is giving a presentation.

In contrast, the techniques discussed herein detect an intent to share audio data of the media content item 132 displayed in the user interface 130 of the source device 102 with the one or more remote devices 104, and automatically enable a playback sharing setting to communicate the audio data for playback at the one or more remote devices 104. Further, the described techniques automatically disable the playback sharing setting to prevent communication of unwanted audio in response to the playback of the intended media content item 132 terminating. By doing so, the described techniques reduce call disruptions and improve user satisfaction with the voice/video call system 124, 126.

Having discussed an example environment in which the disclosed techniques can be performed, consider now some example scenarios and implementation details for implementing the disclosed techniques.

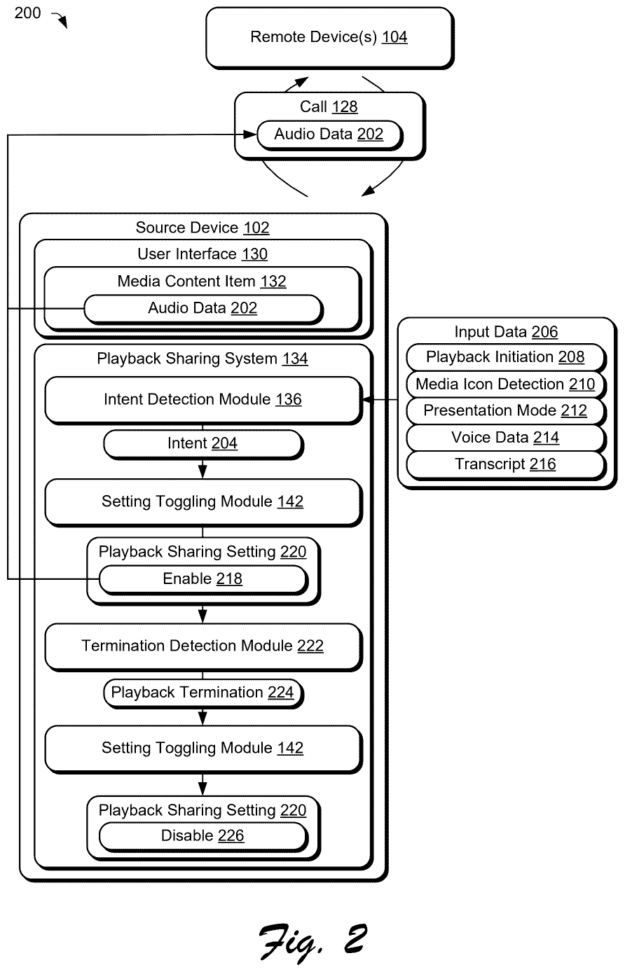

FIG. 2 illustrates an example system 200 for dynamic audio sharing during voice and video calls. In the system 200, a call 128 (e.g., a voice call or a video call) is initiated between the source device 102 and one or more remote devices 104. During the call 128, a user interface 130 of the source device 102 is displaying a media content item 132. When playback of the media content item 132 is initiated, audio data 202 of the media content item 132 is configured to be output by the speaker(s) 112 of the source device 102.

As previously mentioned, the playback sharing system 134 includes an intent detection module 136 configured to detect an intent 204 of the source device user 138 to share the audio data 202 for playback at the remote device(s) 104 to be consumed by other users 140 participating on the call 128. The intent 204 is detected based on input data 206 including any one or any combination of a playback initiation 208 of the media content item 132, a media icon detection 210 of media icons indicative of the media content item 132 being played back at the source device 102, operation of the source device 102 in a presentation mode 212, voice data 214 of the source device user 138, and a transcript 216 of spoken words and phrases exchanged between the users 138, 140 participating on the call 128.

In one or more implementations, the intent 204 is detected based on the user 138 initiating playback of the media content item 132 during the call 128, e.g., the playback initiation 208. The playback initiation 208 is detectable in various ways, such as monitoring playback events triggered by multimedia frameworks (e.g., WebRTC, FFmpeg, AVplayer for iOS operating systems, and MediaPlayer for Android operating systems), user inputs to media icons (e.g., play/pause buttons) and/or gestures (e.g., double tap gestures) that initiate audio/visual playback, and monitoring the network 106 connection to detect when a network starts receiving streaming video/audio data. In yet another example, the playback initiation 208 is detected as a received user input followed closely (e.g., within a particular time frame) by activation of the speaker(s) 112. Additionally or alternatively, the playback initiation 208 is detected as a received user input followed closely (e.g., within a particular time frame) by detection of an audio source by the microphone 110 other than call 128 audio.

Additionally or alternatively, the intent detection module 136 includes functionality (e.g., an object detection model) for detecting media icons associated with the media content item 132 indicative of the media content item 132 being played back at the source device 102, e.g., the media icon detection 210. Further, the playback initiation 208 is detected based on the media icon detection 210, in various implementations. Examples of the media icons include, but are not limited to, play/pause buttons, scrub/progress bars and/or sliders, fast forward/rewind buttons, microphone icons, buffering indicators, skip track icons, volume icons, mute icons, live playback icons (e.g., a red dot or “LIVE” label), casting icons, and headphone icons.

Any one or more of a variety of techniques are usable by the intent detection module 136 to detect these media icons, examples of which include accessibility frameworks and/or application programming interfaces (APIs), image recognition, optical character recognition, and object/shape detection. For example, operating systems and platforms often provide accessibility frameworks (e.g., APIs) which expose a tree of user interface elements with metadata describing roles of the user interface elements. Given this, the intent detection module 136 queries the accessibility frameworks and/or APIs with the accessibility elements of a currently visible user interface 130, to obtain their roles (e.g., play/pause, fast forward, rewind progress scrubbing, etc.), and the intent detection module 136 detects the intent 204 based on the roles indicating playback of a media content item 132.

Additionally or alternatively, the intent detection module 136 includes an object detection model, which is a machine learning model (e.g., a convolutional neural network (CNN)) trained to detect the media icons. An example training dataset includes training images. Each training image includes one or more ground truth bounding boxes surrounding one or more media icons, and ground truth labels defining the particular type of media icon defined by the bounding box. During training, the object detection model is prompted to detect media icons in the training images by defining predicted bounding boxes surrounding the media icons in the training images, and assigning predicted labels to the predicted bounding boxes. Parameters (e.g., internal weights) of the object detection model are updated based on a loss function that captures differences between the ground truth bounding boxes and the predicted bounding boxes, as well as between the ground truth labels and the predicted labels. The training is completed after a threshold number of training images are processed, a threshold number of epochs are processed, or the loss converges to a minimum.

In some implementations, the intent 204 to share the audio data 202 for playback at the remote device(s) 104 is based on the playback initiation 208 and/or the media icon detection 210 occurring while the source device 102 operates in a presentation mode 212. As previously mentioned, the presentation mode 212 is a function of the voice/video call system 124 to transmit visual data of a live feed of a user interface 130 (or portion thereof) displayed by the source device 102 to the remote device(s) 104 (e.g., to be displayed in a user interface of the remote device(s) 104) during a video call. In other words, in certain implementations, the intent 204 is not detected unless the source device 102 is operating in the presentation mode 212.

Additionally or alternatively, the intent detection module 136 detects the intent 204 based on voice data 214 captured by microphone(s) 110 of the source device 102 and/or an automatically generated transcript 216 of voice communications exchanged between the users 138, 140 of the source device 102 and remote device(s) 104, respectively. For example, the voice/video call system 124 includes functionality for generating a real-time transcript 216 of the call 128. The transcript 216 can be of words and/or phrases spoken solely by the user 138 of the source device 102 (e.g., the voice data 214) captured by the microphone(s) 110, or the transcript can be of words and/or phrases spoken by all users 138, 140 participating in the call 128. Furthermore, the intent detection module 136 detects the intent 204 to share the audio data 202 for playback at the remote device(s) 104, as expressed in the transcript 216 by any one or more of the users 138, 140. For example, the user 138 states “I will now show you a quick video demonstration of the process from start to finish,” or the user 140 asks “can you share the audio file with the rest of the group?” In various examples, the intent detection module 136 uses machine learning, pre-trained large language models (LLMs), and/or natural language processing to extract the intent 204 from the transcript 216.

As previously mentioned, the intent 204 is detected from any one or any combination of the input data 206. In one example, the intent detection module 136 detects the intent 204 based on the playback initiation 208 occurring while the source device 102 operates in the presentation mode 212. In another example, the intent detection module 136 detects the intent 204 based on the playback initiation 208 occurring within a predetermined time frame of the spoken word(s) and/or phrase(s) of the transcript 216 from which the intent 204 is extracted. In yet another example, the intent detection module 136 detects the intent 204 based on the intent 204 being extracted from the transcript 216 while the source device 102 operates in the presentation mode 212. In a further example, the intent detection module 136 detects the intent 204 based on the playback initiation 208 occurring within a predetermined time frame of the word(s) and/or phrase(s) of the transcript 216 from which the intent 204 is extracted, and while the source device 102 operates in the presentation mode 212.

In response to detecting the intent 204, the setting toggling module 142 enables 218 the playback sharing setting 220. This causes the voice/video call system 124 to communicate the audio data 202 of the media content item 132 that is being played back at the source device 102 for concurrent playback at the one or more remote devices 104, as shown. In various implementations, the playback sharing system 134 identifies the media content item 132 as an intended audio source. Given this, the playback sharing system 134 prevents (e.g., filters out) other audio sources that are played back at the source device 102 from being communicated for playback at the remote device(s) 104 while the audio data 202 of the media content item 132 is being shared. Consider an example in which the playback sharing system 134 detects the intent 204 to share the audio data of the media content item 132, and as such, enables the playback sharing setting 220. While the playback sharing setting 220 is enabled and the audio data 202 of the media content item 132 is being shared, the source device 102 receives a notification that causes an audible output by the speakers 112. Here, the playback sharing system 134 selectively communicates the audio data 202 of the media content item 132 for playback at the remote devices 104, but filters the audio of the notification, thereby preventing unwanted audio sources from disrupting the audio data 202 that was intended to be shared.

In one or more implementations, the setting toggling module 142 automatically enables the playback sharing setting 220 in response to the intent 204 being detected. Additionally or alternatively, the setting toggling module 142 automatically display a prompt in response to the intent 204 being detected. The prompt includes a first user interface element that is selectable to confirm enablement of the playback sharing setting 220, and cause the playback sharing setting 220 to be enabled. In addition, the prompt includes a second user interface element that is selectable to deny enablement of the playback sharing setting 220, and cause the playback sharing setting to remain disabled. In this way, the playback sharing system 134 prevents instances of enabling playback sharing based on false positives, e.g., when the playback sharing system 134 inaccurately detects the intent 204.

A termination detection module 222 is further configured to detect that playback of the media content item 132 has been terminated on the source device 102, e.g., the playback termination 224. In various implementations, the playback termination 224 is based on a user input manually pausing playback of the media content item 132 or closing the media content item 132, the media content item 132 having finished playing until an endpoint, and/or the media content item 132 having been terminated due to errors, e.g., network connectivity errors.

Any one or more of a variety of techniques are usable by the termination detection module 222 to detect the playback termination 224. In one example, the termination detection module 222 detects the playback termination 224 by monitoring playback events triggered by multimedia frameworks and/or web-based media players. In another example, the termination detection module 222 identifies the audio stream associated with the media content item 132, and detects the playback termination 224 as the audio stream having ceased output by the speaker(s) 112. In yet another example, the termination detection module 222 detects media icons in the user interface 130 indicative of playback of the media content item 132 having terminated in accordance with the previously-described techniques, e.g., a play button having converted to a pause button, or a progress indicator having reached an end of a scrub/progress bar.

As shown, the setting toggling module 142 disables 226 the playback sharing setting 220 in response to the playback termination 224 being detected. This prevents audio that is played back at the source device 102 from being communicated for playback at the one or more remote devices 104.

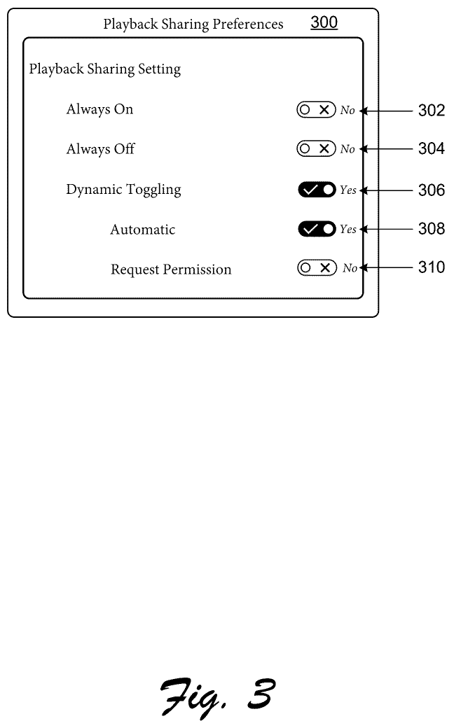

FIG. 3 depicts an example user interface 300 for specifying playback sharing setting preferences of a user. As shown, the user interface 300 includes a user interface element 302 that is selectable to manually enable the playback sharing setting 220, e.g., so that the playback sharing setting 220 is “always on.” In addition, the user interface 300 includes a user interface element 304 that is selectable to manually disable the playback sharing setting 220, e.g., so that the playback sharing setting 220 is “always off.” Further, the user interface 300 includes a user interface element 306 that is selectable to enable dynamic toggling, or in other words, to enable the functionality of the playback sharing system 134 to dynamically enable and disable the playback sharing setting 220 based on the detected intent 204 and playback termination 224, respectively.

The user interface 300 further includes controls for specifying preferences of the dynamic toggling functionality. For example, the user interface element 308 is selectable to specify that the playback sharing setting 220 be enabled automatically (e.g., without requesting permission in a displayed prompt) in response to the intent 204 being detected. Furthermore, the user interface element 310 is selectable to cause display of the prompt in response to the intent 204 being detected. As previously mentioned, the prompt includes user interface elements that are selectable to either confirm enablement of the playback sharing setting 220 or deny enablement of the playback sharing setting 220.

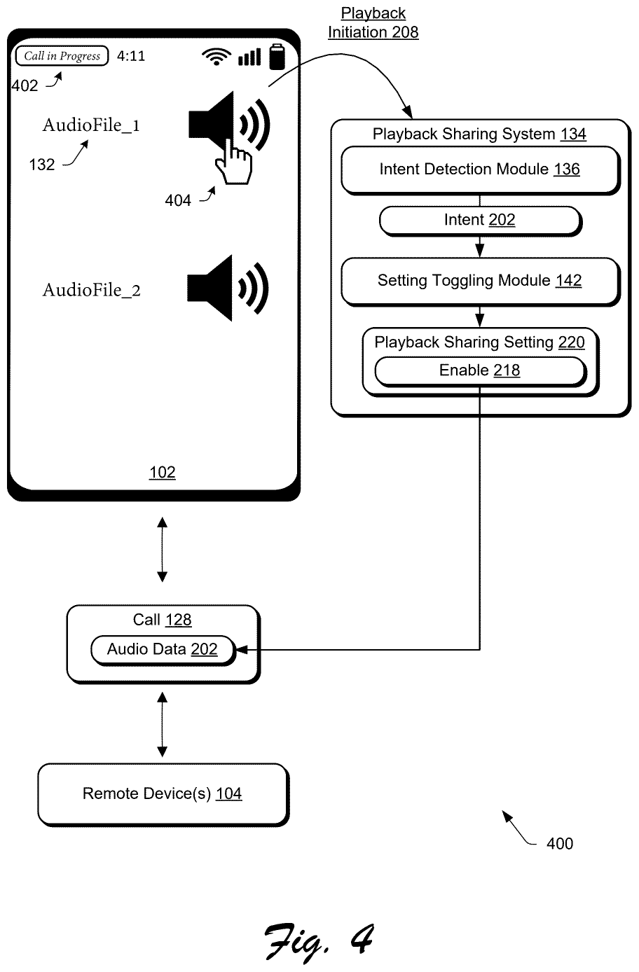

FIG. 4 depicts an example 400 of enabling a playback sharing setting based on a playback initiation. In the example 400, a call 128 (e.g., voice call) is initiated between the source device 102 and the one or more remote devices 104. Further, the source device 102 includes a media content item 132 (e.g., an audio file) displayed in the user interface 130. While the call is in progress (e.g., as illustrated at 402), the user 138 provides user input 404 initiating playback of the media content item 132, e.g., a playback initiation 208. The playback initiation 208 is detected in accordance with the described techniques, and the intent detection module 136 detects the intent 204 of the user 138 to share the audio data 202 based, in part, on the playback initiation 208 being detected during the call 128. In response to detecting the intent 204, the setting toggling module 142 enables 218 the playback sharing setting 220. As part of this, the voice/video call system 124 routes the audio data 202 that is being played back at the source device 102 for playback at the one or more remote devices 104 as part of the call 128, as shown.

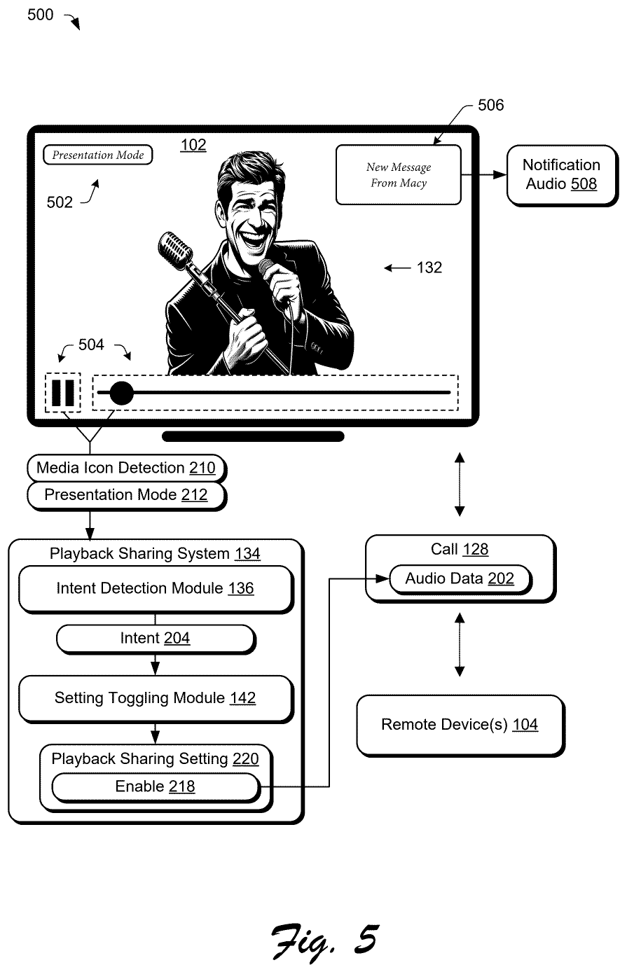

FIG. 5 illustrates an example 500 of enabling a playback sharing setting based on a media icon detection within a user interface of a source device operating in a presentation mode. In the example 400, a call 128 (e.g., a video call) is initiated between the source device 102 and the one or more remote devices 104. The source device 102 includes a media content item 132 (e.g., a video) displayed in the user interface 130. In addition, the source device 102 is operating in the presentation mode (e.g., as illustrated at 502) to transmit visual data of a live feed of the user interface 130 of the source device 102 for display at the remote device(s) 104. While the call 128 is in progress, the user 138 provides user input 404 initiating playback of the media content item 132, and the intent detection module 136 detects one or more media icons 504 (e.g., a pause button and a progress/scrub bar) indicative of the media content item 132 being played back at the source device 102, e.g., the media icon detection 210. Here, the intent detection module 136 detects the intent 204 of the user 138 to share audio data 202 of the media content item 132 based, in part, on the media icon detection 210 occurring while the source device 102 is operating in the presentation mode 212.

In response to detecting the intent 204, the setting toggling module 142 enables 218 the playback sharing setting 220. As part of this, the voice/video call system 124 routes the audio data 202 that is being played back at the source device 102 for playback at the one or more remote devices 104 as part of the call 128, as shown. While the playback sharing setting 220 is enabled to allow the audio data 202 of the media content item 132 to be routed to the remote device(s) 104, the source device 102 receives a notification 506 that causes output of notification audio 508 by the speaker(s) 112 of the source device 102. Here, the playback sharing system 134 identifies the notification audio 508 as an audio source that is external to the audio data 202 of the media content item 132 that is intended to be shared. As such, the voice/video call system 124 prevents the notification audio 508 from being communicated for playback at the remote device(s) 104, as shown, despite the playback sharing setting 220 being enabled.

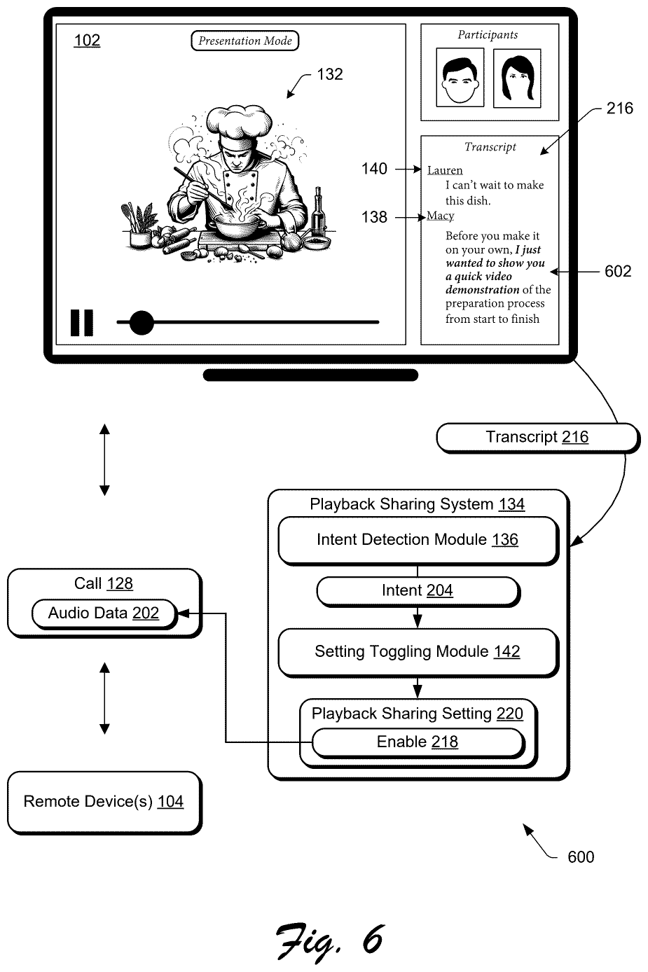

FIG. 6 illustrates an example 600 of enabling a playback sharing setting based on a transcript of a call between a source device and one or more remote devices. In the example 500, a call 128 (e.g., a videoconference) is initiated between the source device 102 and one or more remote devices 104. The source device 102 includes a media content item 132 (e.g., a video) displayed in the user interface 130. As shown, the voice/video call system 124, 126 generates a live transcript of voice communications exchanged between the source device 102 and the remote device(s) 104 during the call 128. The communications include those spoken by the user 138 of the source device 102, and the users 140 of the remote devices 104. Although the transcript 216 is displayed in the user interface 130 of the source device 102, the transcript 216 is generated without being displayed, in some variations. Here, the intent detection module 136 detects the intent 204 to share the audio data 202 of the media content item 132 for playback at the remote device(s) 104, as expressed in the transcript 216. In this example 600, for instance, the intent 204 is extracted from the emphasized language 602 “I just wanted to show you a quick video demonstration,” as spoken by the user 138. In response to detecting the intent 204, the setting toggling module 142 enables 218 the playback sharing setting 220. As part of this, the voice/video call system 124 routes the audio data 202 of the media content item 132 that is being played back at the source device 102 for playback at the one or more remote devices 104 as part of the call 128, as shown.

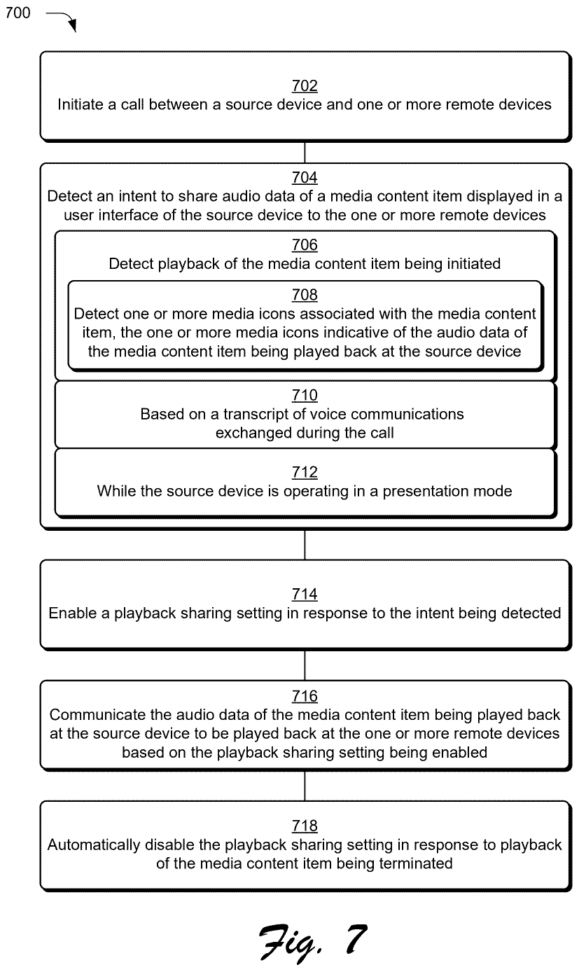

FIG. 7 illustrates a flow chart depicting an example method 700 of dynamic audio sharing during voice and video calls. At 702, a call is initiated between a source device and one or more remote devices. By way of example, a call 128 (e.g., a voice call or a video call) is initiated between the source device 102 and the remote devices 104.

At 704, an intent is detected to share audio data of a media content item displayed in a user interface of the source device to the one or more remote devices. For example, the intent detection module 136 detects the intent 204 to share the audio data 202 of the media content item 132 that is displayed in the user interface 130 of the source device 102 for playback at the one or more remote devices 104.

At 706, the intent to share the audio data is detected as playback of the media content item being initiated. By way of example, the intent detection module 136 receives user input initiating playback of the media content item 132, e.g., the playback initiation 208. Further, the intent detection module 136 detects the intent 204 to share the audio data 202 of the media content item 132 based on the playback initiation 208 being detected during the call 128.

At 708, the playback initiation is detected as one or more media icons associated with the media content item being detected, where the one or more media icons are indicative of the audio data of the media content item being played back at the source device. For instance, the intent detection module 136 detects (e.g., using a trained object detection model) one or more media icons associated with the media content item 132 indicative of the media content item 132 being played back at the source device 102, e.g., the media icon detection 210. Examples of the media icons include a play/pause button, a scrub bar with a progress indicator, fast forward/rewind buttons, and the like. Here, the intent detection module 136 detects the playback initiation 208 based on the media icon detection 210.

At 710, the intent to share the audio data is detected based on a transcript of voice communications exchanged during the call. By way of example, the voice/video call system 124 includes functionality for generating a live transcript 216 of voice communications exchanged during the call 128, e.g., between the users 138, 140. Furthermore, the intent detection module 136 extracts (e.g., using natural language processing techniques) the intent 204 to share audio data 202 from the transcript 216. In variations, the intent 204 to share the audio data is extracted from voice data 214 (e.g., spoken by the user 138) captured by the microphone(s) 110 of the source device 102 without generating a transcript 216

At 712, the intent to share the audio data is detected while the source device is operating in a presentation mode. By way of example, the source device 102 is operating in a presentation mode 212 during the call 128 in which the source device 102 is communicating visual data of a live feed of the user interface 130 (or portion thereof) of the source device 102 to be displayed by the remote device(s) 104. Here, the intent 204 to share the audio data 202 is detected while the source device 102 is operating in the presentation mode 212.

At 714, a playback sharing setting is enabled in response to the intent being detected. In response to the intent 204 being detected on the basis of any one or any combination of the playback initiation 208, the media icon detection 210, while the source device 102 operates in the presentation mode 212, the voice data 214, and the transcript 216, the setting toggling module 142 enables a playback sharing setting 220.

At 716, the audio data of the media content item being played back at the source device is communicated to be played back at the one or more remote devices based on the playback sharing setting being enabled. By enabling the playback sharing setting 220, for instance, the playback sharing system 134 allows the voice/video call system 124 to communicate the audio data 202 that is being played back at the source device 102 for concurrent playback at the remote devices 104. In various implementations, the playback sharing setting 220 also prevents, while the audio data 202 is being shared, other audio sources (e.g., notification audio 508) that are played back at the source device 102 from being shared to the remote devices 104.

At 718, the playback sharing setting is automatically disabled in response to playback of the media content item being terminated. By way of example, the termination detection module 222 detects playback of the media content item 132 being terminated, e.g., the playback termination 224. In response to detecting the playback termination 224, the setting toggling module 142 disables the playback sharing setting, thereby preventing audio that is output at the source device 102 from being communicated for playback at the remote device(s) 104.

The example method described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method

FIG. 8 illustrates various components of an example device 800 in which aspects of dynamic audio sharing during voice and video calls can be implemented. The example device 800 can be implemented as any of the devices described with reference to the previous FIGS. 1-7, such as any type of mobile device, mobile phone, mobile device, wearable device, tablet, computing, communication, entertainment, gaming, media playback, and/or other type of computer, consumer, and/or electronic device. For example, the source device 102 and the remote device(s) 104 as shown and described with reference to FIGS. 1-7 may be implemented as the example device 800.

The device 800 includes communication transceivers 802 that enable wired and/or wireless communication of device data 804 with other devices. The device data 804 can include any of device identifying data, device location data, wireless connectivity data, and wireless protocol data. Additionally, the device data 804 can include any type of audio, video, and/or image data. Example communication transceivers 802 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 800 may also include one or more data input ports 806 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 810. The device 800 may further include any type of a system bus or other data and command transfer system that couples the various components within the device. A system bus can include any one or combination of different bus structures and architectures, as well as control and data lines.

The device 800 also includes computer-readable storage memory 812 (e.g., memory devices) that enable data storage, such as data storage devices that can be accessed by a computing device, and that provide persistent storage of data and executable instructions (e.g., software applications, programs, functions, and the like). Examples of the computer-readable storage memory 812 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 800 may also include a mass storage media device.

The computer-readable storage memory 812 provides data storage mechanisms to store the device data 804, other types of information and/or data, and various device applications 814 (e.g., software applications). For example, an operating system 816 can be maintained as software instructions with a memory device and executed by the processing system 808. The device applications 814 may also include a device manager, such as any form of a control application, software application, signal-processing and control module, code that is native to a particular device, a hardware abstraction layer for a particular device, and so on. Computer-readable storage memory 812 represents media and/or devices that enable persistent and/or non-transitory storage of information in contrast to mere signal transmission, carrier waves, or signals per se. Computer-readable storage memory 812 do not include signals per se or transitory signals.

In this example, the device 800 includes a playback sharing system 818 that implements aspects of dynamic audio sharing during voice and video calls and may be implemented with hardware components and/or in software as one of the device applications. For example, the playback sharing system 818 can be implemented as the playback sharing system 134, described in detail above. In implementations, the playback sharing system 818 may include independent processing, memory, and logic components as a computing and/or electronic device integrated with the device 800.

In this example, the example device 800 also includes a camera 820 and sensors 822. The sensors, for instance, may include motion sensors such as may be implemented in an inertial measurement unit (IMU). The motion sensors can be implemented with various sensors, such as a gyroscope, an accelerometer, and/or other types of motion sensors to sense motion of the device. The various motion sensors may also be implemented as components of an inertial measurement unit in the device. Additionally or alternatively, the sensors include global positioning system (GPS) sensors for location tracking.

The device 800 also includes a wireless module 824, which is representative of functionality to perform various wireless communication tasks. The device 800 can also include one or more power sources 826, such as when the device is implemented as a mobile device. The power sources 826 may include a charging and/or power system, and can be implemented as a flexible strip battery, a rechargeable battery, a charged super-capacitor, and/or any other type of active or passive power source.

The device 800 also includes an audio and/or video processing system 828 that generates audio data for an audio system 830 and/or generates display data for a display system 832. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 834. In implementations, the audio system and/or the display system are integrated components of the example device. Alternatively, the audio system and/or the display system are external, peripheral components to the example device.

Although implementations of dynamic audio sharing during voice and video calls have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a source device including: at least one memory; and at least one processor coupled with the at least one memory and configured to cause the source device to: initiate a call between the source device and one or more remote devices; detect, during the call, an intent to share audio data of a media content item displayed in a user interface of the source device to the one or more remote devices; enable a playback sharing setting in response to the intent being detected; and communicate the audio data of the media content item being played back at the source device to be played back at the one or more remote devices based on the playback sharing setting being enabled.

In some aspects, the techniques described herein relate to a source device, wherein the at least one processor is further configured to cause the source device to automatically disable the playback sharing setting in response to playback of the media content item being terminated.

In some aspects, the techniques described herein relate to a source device, wherein disablement of the playback sharing setting prevents audio that is played back at the source device from being communicated for playback to the one or more remote devices.

In some aspects, the techniques described herein relate to a source device, wherein the at least one processor is further configured to cause the source device to prevent, while the audio data is being communicated for playback at the one or more remote devices, at least one other audio source that is played back at the source device from being communicated for playback at the one or more remote devices.

In some aspects, the techniques described herein relate to a source device, wherein the at least one processor is further configured to cause the source device to detect the intent based on playback of the media content item being initiated during the call.

In some aspects, the techniques described herein relate to a source device, wherein the at least one processor is further configured to cause the source device to: initiate, during the call, a presentation mode in which at least a portion of the user interface of the source device is shared for presentation at the one or more remote devices; and enable the playback sharing setting in response to the intent being detected while the source device is operating in the presentation mode.

In some aspects, the techniques described herein relate to a source device, wherein the at least one processor is further configured to cause the source device to detect the intent based on voice data detected by a microphone of the source device during the call.

In some aspects, the techniques described herein relate to a source device, wherein the at least one processor is configured to cause the source device to: generate a transcript of voice communications exchanged during the call; and detect the intent based on the transcript.

In some aspects, the techniques described herein relate to a source device, wherein the at least one processor is further configured to cause the source device to: detect one or more media icons associated with the media content item, the one or more media icons indicative of the audio data of the media content item being played back at the source device; and detect the intent based on the one or more media icons.

In some aspects, the techniques described herein relate to a source device, wherein the call is a voice call or a video call.

In some aspects, the techniques described herein relate to a source device, wherein the at least one processor is further configured to cause the source device to: display a user interface element that is selectable to enable the playback sharing setting in response to the intent being detected; and enable the playback sharing setting in response to receiving a user selection of the user interface element.

In some aspects, the techniques described herein relate to a system including: at least one memory; and at least one processor coupled with the at least one memory and configured to cause the system to: initiate a call between a source device and one or more remote devices; generate a transcript of voice communications exchanged during the call; detect an intent to share audio data of a media content item displayed in a user interface of the source device to the one or more remote devices based on the transcript; automatically enable a playback sharing setting in response to the intent being detected; and communicate the audio data of the media content item being played back at the source device to be played back at the one or more remote devices based on the playback sharing setting being enabled.

In some aspects, the techniques described herein relate to a system, wherein the at least one processor is further configured to cause the system to automatically disable the playback sharing setting in response to playback of the media content item being terminated.

In some aspects, the techniques described herein relate to a system, wherein disablement of the playback sharing setting prevents audio that is played back at the source device from being communicated for playback to the one or more remote devices.

In some aspects, the techniques described herein relate to a system, wherein the at least one processor is further configured to cause the system to prevent, while the audio data is being communicated for playback at the one or more remote devices, at least one other audio source that is played back at the source device from being communicated for playback at the one or more remote devices.

In some aspects, the techniques described herein relate to a method implemented by a source device, the method including: initiating a call between the source device and one or more remote devices; detecting an intent to share audio data of a media content item displayed in a user interface of the source device to the one or more remote devices, the intent detected based on playback of the media content item being initiated during the call; automatically enabling a playback sharing setting in response to the intent being detected; and communicate the audio data of the media content item being played back at the source device to be played back at the one or more remote devices based on the playback sharing setting being enabled.

In some aspects, the techniques described herein relate to a method, further including automatically disabling the playback sharing setting in response to the playback of the media content item being terminated, thereby preventing audio that is played back at the source device from being communicated for playback at the one or more remote devices.

In some aspects, the techniques described herein relate to a method, further including preventing, while the audio data is being communicated for playback at the one or more remote devices, at least one other audio source that is played back at the source device from being communicated for playback at the one or more remote devices.

In some aspects, the techniques described herein relate to a method, further including: initiating, during the call, a presentation mode in which at least a portion of the user interface of the source device is shared for presentation at the one or more remote devices; and detecting the intent based on the playback of the media content item being initiated while the source device is operating in the presentation mode.

In some aspects, the techniques described herein relate to a method, further including: detecting one or more media icons associated with the media content item, the one or more media icons indicative of the audio data of the media content item being played back at the source device; and detecting the intent based on the one or more media icons.

What is claimed is:

1. A source device comprising:
at least one memory; and
at least one processor coupled with the at least one memory and configured to cause the source device to:
initiate a call between the source device and one or more remote devices;
detect, during the call, an intent to share audio data of a media content item displayed in a user interface of the source device to the one or more remote devices;
enable a playback sharing setting in response to the intent being detected; and
communicate the audio data of the media content item being played back at the source device to be played back at the one or more remote devices based on the playback sharing setting being enabled.

2. The source device of claim 1, wherein the at least one processor is further configured to cause the source device to automatically disable the playback sharing setting in response to playback of the media content item being terminated.

3. The source device of claim 2, wherein disablement of the playback sharing setting prevents audio that is played back at the source device from being communicated for playback to the one or more remote devices.

4. The source device of claim 1, wherein the at least one processor is further configured to cause the source device to prevent, while the audio data is being communicated for playback at the one or more remote devices, at least one other audio source that is played back at the source device from being communicated for playback at the one or more remote devices.

5. The source device of claim 1, wherein the at least one processor is further configured to cause the source device to detect the intent based on playback of the media content item being initiated during the call.

6. The source device of claim 1, wherein the at least one processor is further configured to cause the source device to:
initiate, during the call, a presentation mode in which at least a portion of the user interface of the source device is shared for presentation at the one or more remote devices; and
enable the playback sharing setting in response to the intent being detected while the source device is operating in the presentation mode.

7. The source device of claim 1, wherein the at least one processor is further configured to cause the source device to detect the intent based on voice data detected by a microphone of the source device during the call.

8. The source device of claim 1, wherein the at least one processor is configured to cause the source device to:
generate a transcript of voice communications exchanged during the call; and
detect the intent based on the transcript.

9. The source device of claim 1, wherein the at least one processor is further configured to cause the source device to:
detect one or more media icons associated with the media content item, the one or more media icons indicative of the audio data of the media content item being played back at the source device; and
detect the intent based on the one or more media icons.

10. The source device of claim 1, wherein the call is a voice call or a video call.

11. The source device of claim 1, wherein the at least one processor is further configured to cause the source device to:
display a user interface element that is selectable to enable the playback sharing setting in response to the intent being detected; and
enable the playback sharing setting in response to receiving a user selection of the user interface element.

12. A system comprising:
at least one memory; and
at least one processor coupled with the at least one memory and configured to cause the system to:
initiate a call between a source device and one or more remote devices;
generate a transcript of voice communications exchanged during the call;
detect an intent to share audio data of a media content item displayed in a user interface of the source device to the one or more remote devices based on the transcript;
automatically enable a playback sharing setting in response to the intent being detected; and
communicate the audio data of the media content item being played back at the source device to be played back at the one or more remote devices based on the playback sharing setting being enabled.

13. The system of claim 12, wherein the at least one processor is further configured to cause the system to automatically disable the playback sharing setting in response to playback of the media content item being terminated.

14. The system of claim 13, wherein disablement of the playback sharing setting prevents audio that is played back at the source device from being communicated for playback to the one or more remote devices.

15. The system of claim 12, wherein the at least one processor is further configured to cause the system to prevent, while the audio data is being communicated for playback at the one or more remote devices, at least one other audio source that is played back at the source device from being communicated for playback at the one or more remote devices.

16. A method implemented by a source device, the method comprising:
initiating a call between the source device and one or more remote devices;
detecting an intent to share audio data of a media content item displayed in a user interface of the source device to the one or more remote devices, the intent detected based on playback of the media content item being initiated during the call;
automatically enabling a playback sharing setting in response to the intent being detected; and
communicate the audio data of the media content item being played back at the source device to be played back at the one or more remote devices based on the playback sharing setting being enabled.

17. The method of claim 16, further comprising automatically disabling the playback sharing setting in response to the playback of the media content item being terminated, thereby preventing audio that is played back at the source device from being communicated for playback at the one or more remote devices.

18. The method of claim 16, further comprising preventing, while the audio data is being communicated for playback at the one or more remote devices, at least one other audio source that is played back at the source device from being communicated for playback at the one or more remote devices.

19. The method of claim 16, further comprising:
initiating, during the call, a presentation mode in which at least a portion of the user interface of the source device is shared for presentation at the one or more remote devices; and
detecting the intent based on the playback of the media content item being initiated while the source device is operating in the presentation mode.

20. The method of claim 16, further comprising:
detecting one or more media icons associated with the media content item, the one or more media icons indicative of the audio data of the media content item being played back at the source device; and
detecting the intent based on the one or more media icons.
